(19) United States
(12) Patent Application Publication
(10) Pub. No.: US 2026/0308047 A1
(43) Pub. Date: Oct. 8, 2026

(54) GLASS MATERIAL AND OPTICAL FIBER

(71) Applicant: SUMITOMO ELECTRIC INDUSTRIES, LTD., Osaka (JP)

(72) Inventors: Shin SATO, Osaka (JP); Takemi HASEGAWA, Osaka (JP); Shinji ISHIKAWA, Osaka (JP)

(21) Appl. No.: 18/879,048

(22) PCT Filed: Jun. 6, 2023
(86) PCT No.: PCT/JP2023/021030

§ 371 Date: Dec. 26, 2024

(30) Foreign Application Priority Data
Jun. 29, 2022 (JP) 2022-104468

(51) Int. Cl. C03C 13/04; G02B 6/02

(52) U.S. Cl. CPC C03C 13/046; G02B 6/02395

(57) ABSTRACT

A glass material according to the present invention includes a silica glass and a group 15 element. The concentration ratio of the single bonds and multiple bonds of the group 15 element satisfies [single bonds]/[multiple bonds]≥1. An optical fiber includes a core including silica-based glass and a group 15 element and a cladding including silica-based glass and surrounding the core. In the core, a concentration ratio of a single bond to a double bond of the group 15 element satisfies [single bond]/[double bond]≥1.

### TECHNICAL FIELD

The present disclosure relates to a glass material and an optical fiber. This application claims priority based on Japanese Patent Application No. 2022-104468 filed on Jun. 29, 2022, and the entire contents of the Japanese patent application are incorporated herein by reference.

### BACKGROUND ART

Non-patent literature 1 discloses that the refractive index increases in oxynitride glass, that is, nitrogen-containing glass. Non-patent Literature 2 discloses that the ultraviolet absorption of phosphorus-containing glass shifts to the short wavelength side. Glasses including a group 15 element such as nitrogen and phosphorus can generally shift ultraviolet absorption to a shorter wavelength side than pure silica glass, and thus can be utilized as optical glass in a wide wavelength range.

### CITATION LIST

### Non Patent Literature

Non-patent literature 1: Hampshire, Pomeroy, “Oxynitride Glasses”, Int. J. Appl. Ceram. Technol., 5 [2] 155-163 (2008)
Non-Patent Literature 2: Kohei Kadono, “Optical Properties of Glass, I.”, NEW GLASS Vol. 24 No. 1 p. 59-63 (2009)

### SUMMARY OF INVENTION

A glass material according to an aspect of the present disclosure includes silica-based glass and a group 15 element. A concentration ratio of a single bond to a double bond of the group 15 element satisfies [single bond]/[double bond]≥1.

### BRIEF DESCRIPTION OF THE DRAWINGS

FIG. 1 is a cross-sectional view showing an optical fiber according to an embodiment.

FIG. 2 is a graph showing the relationship between concentration ratio and transmission loss.

### DETAILED DESCRIPTION

### Problems to be Solved by Present Disclosure

In glasses including group 15 elements, particularly nitrogen, viscosity and glass transition temperature increase, and thus processing at a high temperature is required. Thus, processability deteriorates and contamination of impurities is likely to occur, so that absorption due to impurities may occur. In this field, a glass material and an optical fiber having a high transmittance in a wide wavelength range are desired.

The object of the present disclosure is to provide glass materials and optical fibers having a high transmittance in a wide wavelength range.

### Advantageous Effects of Present Disclosure

According to the present disclosure, glass materials and optical fibers having a high transmittance in a wide wavelength range can be provided.

### Description of Embodiments of the Present Disclosure

First, embodiments of the present disclosure will be listed and described.
(1) A glass material according to an aspect of the present disclosure includes silica-based glass and a group 15 element. A concentration ratio of a single bond to a double bond of the group 15 element satisfies [single bond]/[double bond]≥1. This glass material achieves a high transmittance in a wide wavelength range.
(2) In the glass material according to (1), the concentration ratio of the single bond to the double bond of the group 15 element may satisfy [single bond]/[double bond] ≥9. In this case, a higher transmittance is achieved in a wide wavelength range.
(3) In the glass material according to (1), the concentration ratio of the single bond to the double bond of the group 15 element may satisfy [single bond]/[double bond] ≥19. In this case, a particularly high transmittance is achieved in a wide wavelength range.
(4) In the glass material according to any one of (1) to (3), a relative refractive index difference based on a refractive index of silica glass may be −0.1% to 0.3%. When this glass material is used for forming a core, it is possible to suppress the excessive addition of a downdopant to a cladding.
(5) The glass material according to any one of (1) to (4) may include silica glass in a mass ratio of 50% or more. In this case, optical characteristics are prevented from being adversely affected.
(6) The glass material according to any one of (1) to (5) may further include an alkali metal element, an alkaline-earth metal element, a group 13 element, or a halogen element. In this case, the valence state of the group 15 element can be stabilized.
(7) A glass material according to another aspect of the present disclosure includes silica-based glass and a group 15 element. A concentration ratio of a single bond to a multiple bond of the group 15 element satisfies [single bond]/[multiple bond]≥1. This glass material achieves a high transmittance in a wide wavelength range.
(8) An optical fiber according to an aspect of the present disclosure includes a core including silica-based glass and a group 15 element, and a cladding including silica-based glass and surrounding the core. In the core, a concentration ratio of a single bond to a double bond of the group 15 element satisfies [single bond]/[double bond]≥1. In this optical fiber, since a high transmittance is achieved in a wide wavelength range, the loss in a transmission wavelength band is reduced.

### Details of Embodiments of Present Disclosure

Specific examples of a glass material and an optical fiber of the present disclosure will be described below with reference to the drawings. It is noted that, the present invention is not limited to these examples, but is defined by the scope of the claims, and is intended to include all modifications within the meaning and scope equivalent to the scope of the claims. In the description of the drawings, the same elements are denoted by the same reference numerals, and redundant description will be omitted.

### (Glass Material)

A glass material according to an embodiment of the present disclosure is, for example, an optical glass material. More specifically, the glass material is, for example, a glass material for an optical fiber, and is used for forming a core of the optical fiber. The glass material is formed of silica-based glass which contains silica glass as a main component. The glass material further contains an element other than silicon (Si) and oxygen (O) constituting silica glass.

The glass material may contain an element that easily becomes a cation, such as an alkali metal element, an alkaline-earth metal element, a group 13 element, or a group 14 element. Examples of the alkali metal element include lithium (Li), sodium (Na), potassium (K), and rubidium (Rb). Examples of the alkaline-earth metal element include magnesium (Mg), calcium (Ca), strontium (Sr), and barium (Ba). Examples of the group 13 element include boron (B), aluminum (Al), gallium (Ga), and indium (In). Examples of the group 14 element include germanium (Ge), tin (Sn), and lead (Pb).

The glass material may particularly contain an element that is likely to stabilize a valence, such as an alkali metal element, an alkaline-earth metal element, or a group 13 element. These elements that are likely to stabilize the valence have an effect of stabilizing the valence of the group 15 element added to the glass material, as described later.

The glass material may include a halogen element. Examples of the halogen element include fluorine (F), chlorine (CI), bromine (Br), and iodine (I). Since the halogen element is an oxidizing agent, as described later, the halogen element has an effect of stabilizing the valence of the group 15 element added to the glass material.

The glass material includes a group 15 element. Examples of the group 15 element include nitrogen (N), phosphorus (P), arsenic (As), antimony (Sb), and bismuth (Bi). The glass material may include two or more kinds of group 15 elements. In the glass material, the concentration ratio of the single bond to the double bond of the group 15 element satisfies [single bond]/[double bond]≥1. That is, the density (abundance) of the group 15 element in the single bond state is equal to or more than the density (abundance) of the group 15 element in the double bond state. The concentration ratio of the single bond to the double bond of the group 15 element may satisfy [single bond]/[double bond]≥9, and may satisfy [single bond]/[double bond]≥19.

In the glass material, the concentration ratio of the single bond to the multiple bond of the group 15 element satisfies [single bond]/[multiple bond]≥1. That is, the density (abundance) of the group 15 element in the single bond state is equal to or more than the density (abundance) of the group 15 element in the multiple bond state. The concentration ratio of the single bond to the multiple bond of the group 15 element may satisfy [single bond]/[multiple bond]≥9, and may satisfy [single bond]/[multiple bond]≥19.

Nitrogen tends to be trivalent. Nitrogen can take various bonding states in the glass material, for example, from a double bond such as Si═N to a single bond such as Si—N. In general, the stronger the bond strength, the better the chemical durability of the glass produced. On the other hand, as the bonding strength is higher, the viscosity and the glass transition temperature are more likely to increase, and thus, it is necessary to process the glass by applying a higher temperature. Processing at high temperature is not suitable for the production of optical glass because impurities such as water are likely to be mixed.

When the glass material contains many single bond states such as Si—N, the glass material can maintain the viscosity and the glass transition point in a low state while improving the chemical durability as compared with pure silica glass. In order to increase the ratio of nitrogen in the single bond state, nitrogen may be added at a temperature and a pressure as high as possible. The high temperature and high pressure break the triple bond of nitrogen molecules (N₂), and nitrogen is easily added in a single bond. Nitrogen may be ionized by using plasma or the like, or a material containing many single bonds such as ammonia (NH₃) may be used as the additive material.

Although arsenic and antimony tend to take on a trivalent state, it is known that they are more likely to have various valences than nitrogen and phosphorus due to the characteristics of the elements. Thus, the valence state of arsenic and antimony may be stabilized by adding an element that easily stabilizes the valence, such as an alkali metal element, an alkaline-earth metal element, or a halogen element. In particular, a halogen element may be co-added. The molar concentration of the total of arsenic and antimony added may be 0.1 times to 10 times, 2 times to 5 times, or 2.5 times to 3.5 times the molar concentration of the total of the halogen elements added.

Phosphorus easily takes on a pentavalent state, and thus, particular attention is required. The number of bonding hands of silicon is four, whereas the number of bonding hands of phosphorus is five. Thus, when silicon is substituted with phosphorus, the remaining one hand is likely to contribute to a double bond. Thus, the viscosity is easily increased. Further, as a result of the strain given to the glass structure, the generation of defects is promoted, and the absorption component on the shorter wavelength, that is, in the ultraviolet region, increases. Such a glass material is not suitable for optical glass which is required to have a high transmittance in a wide wavelength range. Thus, for phosphorus, a method of dispersing bonding hands by adding an element such as an alkali metal element or an alkaline-earth metal element may be adopted.

When the total addition amount (molar concentration) of the alkali metal element is x and the total addition amount (molar concentration) of the alkaline-earth metal element is y, x+2y may be 0.1 times or more and 10 times or more, 0.5 times to 2 times, or 0.9 times to 1.2 times the addition amount (molar concentration) of phosphorus. The alkali metal element is bonded to phosphorus at a ratio of 1:1, and the bonding state of phosphorus can be a single bond. Thus, the addition amount of the alkali metal element may be larger than the addition amount of the alkaline-earth metal element.

A relative refractive index difference Δ of the glass material based on the refractive index of pure silica glass (SiO₂), that is, silica glass, may be −0.1% to 0.3%, 0.0% to 0.3%, or 0.1% to 0.3%. When such a glass material is used for forming the core, it is possible to suppress the excessive addition of a downdopant such as F to the cladding. Thus, an increase in transmission loss due to an increase in the concentration of the additive can be suppressed.

Any of the group 15 elements are upper dopants, and are added in accordance with the refractive index of the glass material of interest. The group 15 element may be added to the glass material as much as possible. When a single element is added, that is, when only one kind of group 15 element is added, the mass ratio of phosphorus may be 50 ppm or more, 1000 ppm or more, or 50000 ppm or more. In the case of nitrogen, the mass ratio may be 50 ppm or more, 1000 ppm or more, or 20000 ppm or more. In the case of arsenic, the mass ratio may be 50 ppm or more, 1000 ppm or more, or 10000 ppm or more. In the case of antimony, the mass ratio may be 50 ppm or more, 1000 ppm or more, or 6000 ppm or more. Here, the mass ratio means a mass fraction.

When the phase separation of an additive substance occurs due to the addition of multiple elements, the optical characteristics are adversely affected. Thus, the ratio of silica glass as the main component may be 50% or more, 80% or more, or 90% or more in mass ratio. Here, the mass ratio means a mass fraction.

The bonding state of phosphorus and oxygen is evaluated by, for example, X-ray photoelectron spectroscopy (XPS). The peak of the spectrum caused by the bonding state of P═O is observed between 533 and 535 eV. The peak of the spectrum caused by the bonding state of P—O is observed between 532 and 533 eV. Fitting is performed on these peaks using Gaussian functions to identify the peaks. The concentration ratio of the bonding state (the ratio of the amount of the bonding state) is obtained from the area intensity ratio of the obtained fitting function.

The bonding state of nitrogen and silicon is also evaluated by, for example, XPS. When a double bond (Si═N) is contained, the peak of the spectrum is observed at 397.9 eV. In the case of only a single bond (Si—N), the peak of the spectrum is observed at 399.4 eV. Fitting is performed on these peaks using Gaussian functions to identify the peaks. The concentration ratio of the bonding state (the ratio of the amount of the bonding state) is obtained from the area intensity ratio of the obtained fitting function. The concentration ratio [N single bond]/[N double bond] of the single bond to the double bond of nitrogen may be 1 or more, 9 or more, or 19 or more.

The bonding state of arsenic and oxygen and the bonding state of antimony and oxygen are also evaluated by, for example, XPS. In the case of arsenic, the peak of the spectrum caused by the trivalent is observed between 44.5 and 45.5 eV, and the peak of the spectrum caused by the pentavalent is observed between 45.5 and 46.5 eV. In the case of antimony, the peak of the spectrum caused by the trivalent is observed between 529.5 and 530.5 eV, and the peak of the spectrum caused by the pentavalent is observed between 530.5 and 531.5 eV. Fitting is performed on these peaks using Gaussian functions to identify the peaks. The concentration ratio of the bonding state (the ratio of the amount of the bonding state) is obtained for each of arsenic and antimony from the area intensity ratio of the obtained fitting function.

The glass material is synthesized by a plasma melting method, a high-pressure synthesis method, or the like. In order to prevent the contamination of impurities as much as possible, the material of the member such as the furnace used for the production may be quartz which is the same element as the glass material.

### (Optical Fiber)

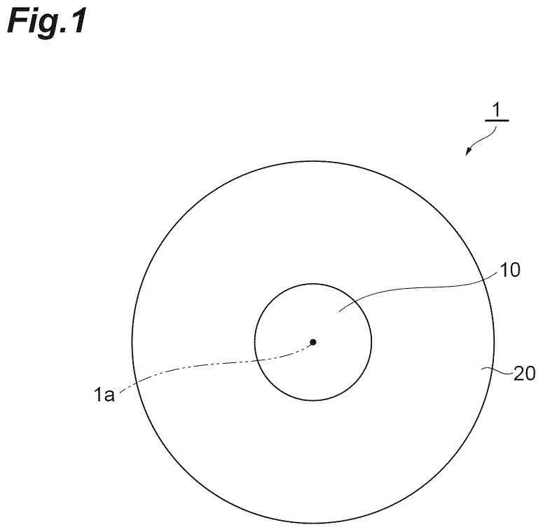

FIG. 1 is a cross-sectional view showing an optical fiber according to an embodiment. An optical fiber 1 according to the embodiment includes a core 10 extending along a central axis 1a and a cladding 20 surrounding core 10. Optical fiber 1 is formed using the glass material according to the embodiment. More specifically, core 10 is formed using the glass material according to the embodiment. Cladding 20 is made of silica-based glass containing silica glass as a main component.

Table 1 shows the relationship between concentration ratio and transmission loss.

TABLE 1

| [N single bond]/[N double bond] | Transmission loss [dB/km] |
|---|---|
| 0.02 | 0.19 |
| 0.1 | 0.183 |
| 1 | 0.165 |
| 5.6 | 0.162 |
| 10 | 0.158 |
| 53 | 0.156 |
| 100 | 0.153 |
| 223 | 0.151 |
| 986 | 0.149 |

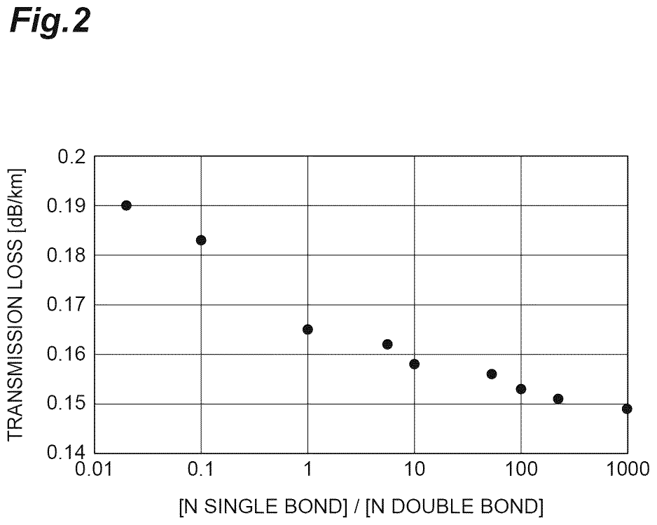

FIG. 2 is a graph showing the relationship between the concentration ratio and the transmission loss. As shown in table 1 and FIG. 2, it is understood that the transmission loss tends to decrease as the concentration ratio increases. When [N single bond]/[N double bond]≥1 is satisfied, it can be confirmed that the transmission loss is suppressed to 0.165 dB/km or less.

Although the embodiments have been described, the present disclosure is not necessarily limited to the embodiments and variations described above, and many modifications are possible without departing from the gist thereof.

### REFERENCE SIGNS LIST

1 optical fiber
1a central axis
10 core
20 cladding

What is claimed is:

1. A glass material comprising silica-based glass and a group 15 element,
wherein a concentration ratio of a single bond to a double bond of the group 15 element satisfies [single bond]/[double bond]≥1.

2. The glass material according to claim 1,
wherein the concentration ratio of the single bond to the double bond of the group 15 element satisfies [single bond]/[double bond]≥9.

3. The glass material according to claim 1,
wherein the concentration ratio of the single bond to the double bond of the group 15 element satisfies [single bond]/[double bond]≥19.

4. The glass material according to claim 1,
wherein a relative refractive index difference based on a refractive index of silica glass is −0.1% to 0.3%.

5. The glass material according to claim 1, comprising silica glass in a mass ratio of 50% or more.

6. The glass material according to claim 1, further comprising an alkali metal element, an alkaline-earth metal element, a group 13 element, or a halogen element.

7. A glass material comprising silica-based glass and a group 15 element,
wherein a concentration ratio of a single bond to a multiple bond of the group 15 element satisfies [single bond]/[multiple bond]≥1.

8. An optical fiber comprising:
a core including silica-based glass and a group 15 element; and
a cladding including silica-based glass and surrounding the core,
wherein, in the core, a concentration ratio of a single bond to a double bond of the group 15 element satisfies [single bond]/[double bond]≥1.
